(19) United States
(12) Patent Application Publication
(10) Pub. No.: US 2021/0116108 A1
(43) Pub. Date: Apr. 22, 2021

(54) Adjustable Lamp

(71) Applicant: Gustavo Osborne, T res Ros (CR)

(72) Inventor: Gustavo Osborne, T res Ros (CR)

(21) Appl. No.: 16/654,518

(22) Filed: Oct. 16, 2019

(51) Int. Cl. F21V 21/24; F21V 29/70; G03B 15/02; F21V 21/116; F21V 21/088

(52) U.S. Cl. CPC F21V 21/24; F21V 29/70; F21Y 2115/10; F21V 21/116; F21V 21/088; G03B 15/02

(57) ABSTRACT

The adjustable lamp is used to achieve different lighting schemes or configurations for video, photography or multimedia purposes, even from just one lamp. The adjustable lamp has more than one lighting element or group of bulbs, meaning that the bulbs are separated in independent groups. The position of each lighting element can be adjusted via its' adjustable mechanism, which allows the user to configure the position of the lighting elements in the lamp to achieve different lighting configurations or schemes. The overall effective size of the lamp ca be changed as well as the direction of the light of each separate element, which creates different lighting results with the same lamp. The adjustable lamp can be mounted on any support or stand, including directly to the camera using a “DSLR rig” or other accessory.

### FIELD OF INVENTION

This invention relates to lighting equipment. To be more specific, this invention pertains to a lamp for photography, video or any image capture application.

### BACKGROUND

The quality of the light produced by a lamp has a direct relation to the size of the effective light source. The bigger the effective light source the softer the light (i.e. the shadows are more diffused with soft edges). The smaller the effective light source the harder the light (i.e. the shadows are crisp and dark with hard edges). This is one of the main concepts applied in general lighting and in photography, video and multi-media production.

In many cases more than one lamp is used to produce the desired result. In some cases a number of hard light sources together can produce a light that is softer.

Traditional light modifiers such as reflectors, umbrellas, softboxes, snoots, grids and many others have been used to modify the light quality provided by the lamp. In other instances more than one lamp can be used to obtain a similar effect.

In many cases lamps are somehow directly attached to the camera or through the use of different devices, mounts or supports.

Presently there is no solution for a lamp that can be continuously adjusted (collapsed or expanded) to modify its effective size and direction of the light, and at the same time modify the quality of the light it produces, attached to the camera or separated from it.

### BRIEF SUMMARY OF THE INVENTION

The present invention seeks to provide a solution to these problems by providing a lamp that can have its size adjusted by modifying the distance and position between its lighting elements or bulbs and thus modifying the quality or softness and direction of the light it produces, with or without additional accessories and attached to the camera or separated from it.

### BRIEF DESCRIPTION OF THE DRAWINGS

FIG. 1 shows the adjustable lamp with the elements collapsed or without separation, as a smaller light source.

FIG. 2 shows the adjustable lamp with the elements expanded, creating a bigger light source.

FIG. 3 shows the adjustable lamp with the elements collapsed, as a smaller light source, showing the adjustable mechanism in the back.

FIG. 4 shows the adjustable lamp with the elements expanded, creating a bigger light source, showing the adjustable mechanism in the back.

FIG. 5 shows the adjustable lamp mounted on a DSLR type camera “rig” or support, with the elements parallel to each other and perpendicular to the lens' axis, with a small separation between them.

FIG. 6 shows the adjustable lamp mounted on a DSLR type camera “rig” or support, with the elements parallel to each other and perpendicular to the lens' axis, with a bigger separation between them than in FIG. 5, and three elements on one side of the camera, and one element on the other side.

FIG. 7 shows the adjustable lamp mounted on a DSLR type camera “rig” or support, with one element on either side of the camera and tilted in relation to the lens' axis.

FIG. 8 shows the adjustable lamp mounted on a DSLR type camera “rig” or support, with two elements on either side of the camera, tilted approximately 90 degrees in relation to each other and 45 degrees in relation to the lens' axis.

FIG. 9 shows a side view of a section of the adjustable lamp with clamps attached to the back of the lighting elements and clamped to the arm of a light stand, in this particular case said stand is a what is known in the industry as a c-stand.

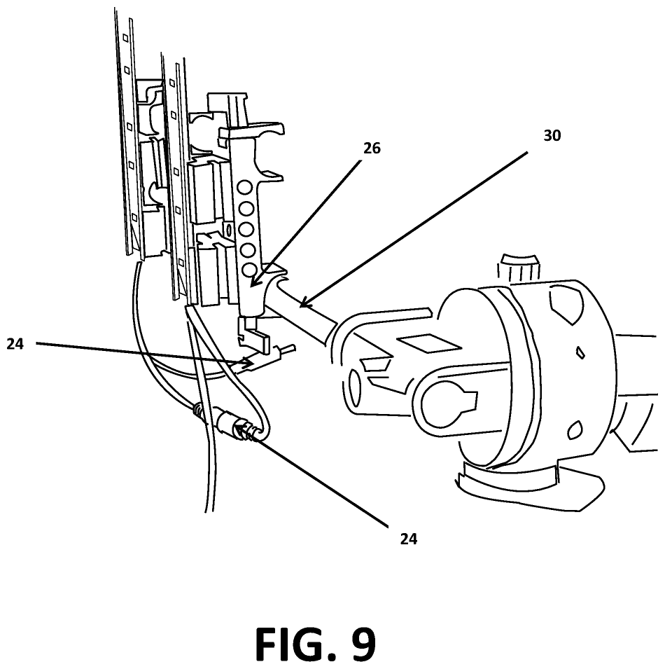

FIG. 10 shows a front view of a section of the adjustable lamp with clamps attached to the back of the lighting elements and clamped to the arm of a light stand, in this particular case said stand is a what is known in the industry as a c-stand.

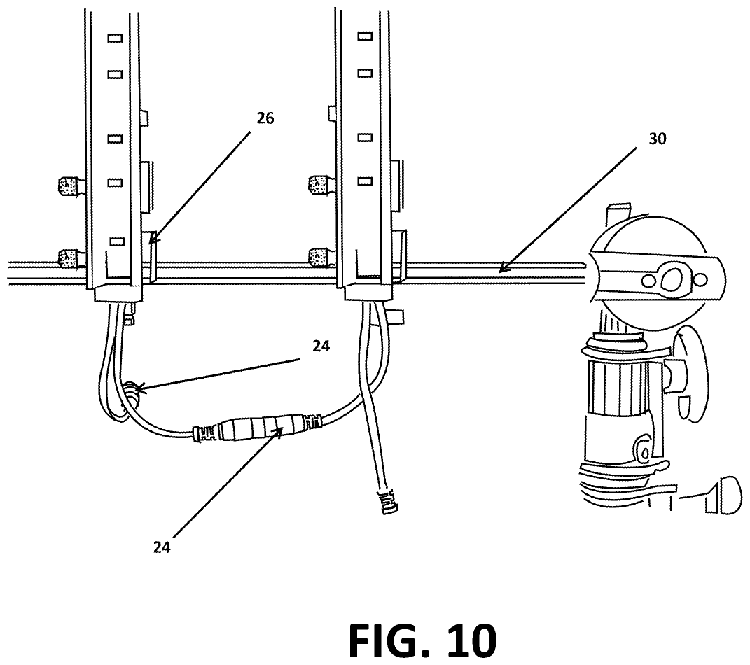

### DETAILED DESCRIPTION AND BEST MODE OF IMPLEMENTATION

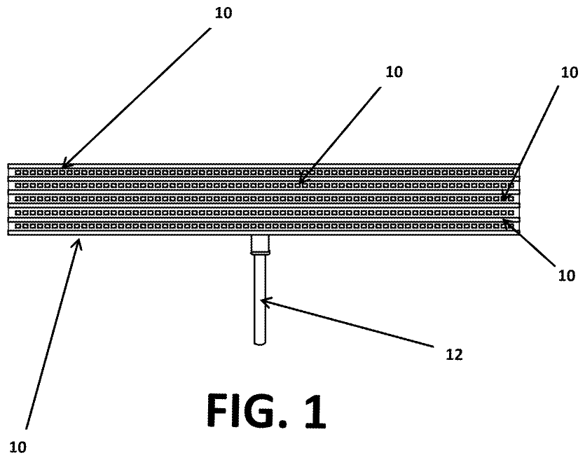

Referring now to the invention in more detail, in FIG. 1 there is shown the present invention in an assembled state, with the lighting elements (#10) collapsed. The lighting elements (#10) are groups of one or more bulbs or any light producing artifact, included but not limited to LED, incandescent, fluorescent, etc. type bulbs, producing continuous or flash or strobe lighting. The light produced can be of any light color temperature and could be adjustable in some implementations. The lighting elements (#10) can be of any shape or form, but most likely will be in shape of a strip, as the lighting elements (#10) shown. The lighting elements (#10) can also be of different sizes and can be mixed and matched as desired or needed for a particular application. In this figure (FIG. 1) the lamp has five lighting elements (#10) but all are close together with no space between them. Although in this FIG. 1. there are five lighting elements (#10), any number of elements can be used, and the user could add or remove elements if the mechanism would allow it. The invention is shown mounted on a typical stand (#12) used for lighting purposes which is not part of the invention. Although there are 5 lighting elements (#10) shown, they appear as been one lamp, since they are all close together without gaps between them. The adjustable lamp in this state would behave just like a traditional lamp.

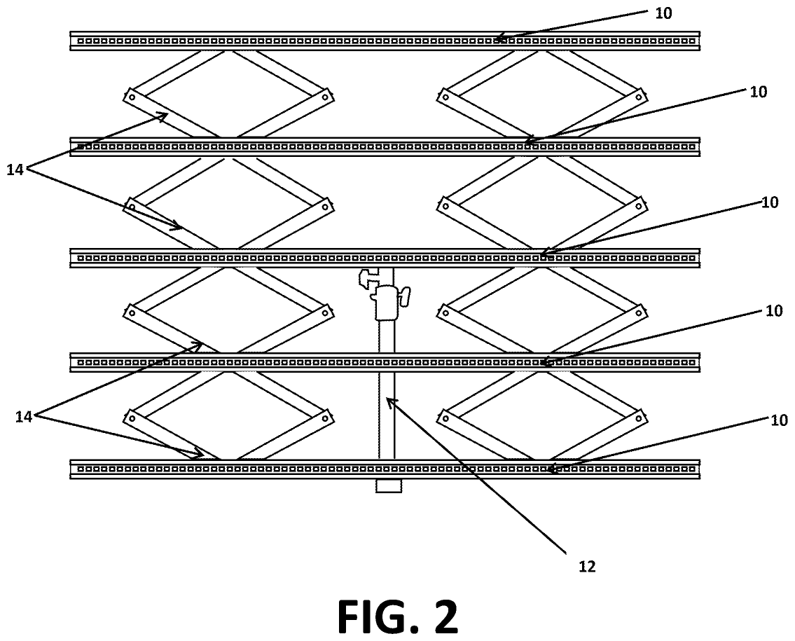

In FIG. 2 there is shown the same lamp as in FIG. 1 but in the expanded mode. In FIG. 2 there is space between the elements (#10). The adjustable mechanism (#14) allows for the lighting elements (#10) to be configured in such a way that the distance and or position of these elements (#10) in relation to each other can change, and in this case they are separated, meaning there is distance between them. In this state, the adjustable lamp will behave as a much larger light source, thus providing a softer light (a light that produces less defined shadows), without the need for additional light modifiers or accessories. This adjustable mechanism (#14) will provide in this case continuous adjustment, in such a way that the lamp can vary its' effective size from completely collapsed to completely extended and everything in between. The light quality produced by the lamp will change as the size is adjusted, so the light quality can also be continuously adjusted without the need for additional accessories.

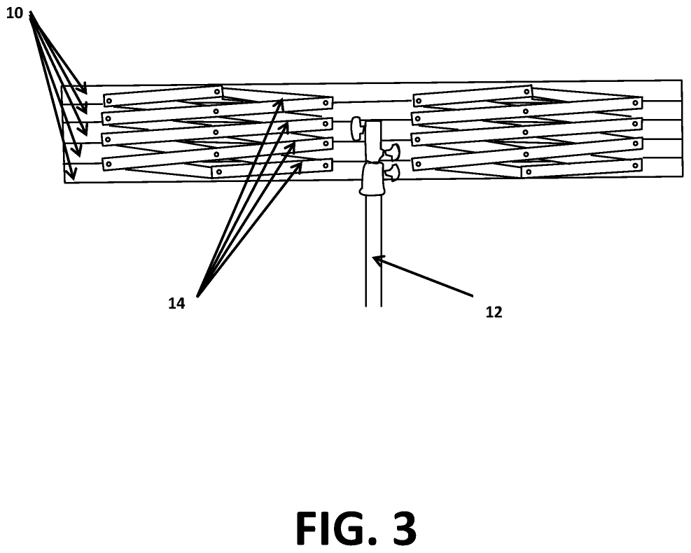

In FIG. 3 there is shown the back of the same adjustable lamp with the adjustable mechanism (#14) collapsed as was shown in FIG. 1, eliminating gaps between the lighting elements (#10). FIG. 3 clearly shows the adjustable mechanism (#14) in the back, which in this case is an accordion type mechanism, but can be any type of mechanism that allows for the lighting elements to be adjusted or separated in different ways, not only regarding distance from each other but position also.

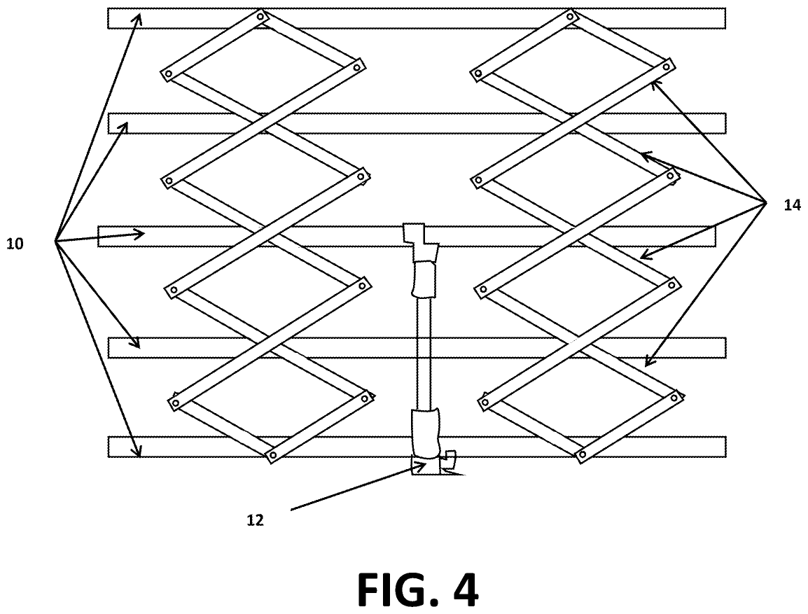

In FIG. 4 there is shown the back of the same adjustable lamp with the adjustable mechanism (#14) expanded, creating gaps between the lighting elements (#10) and thus creating a much bigger effective size and softer light that in FIG. 1 and or FIG. 3.

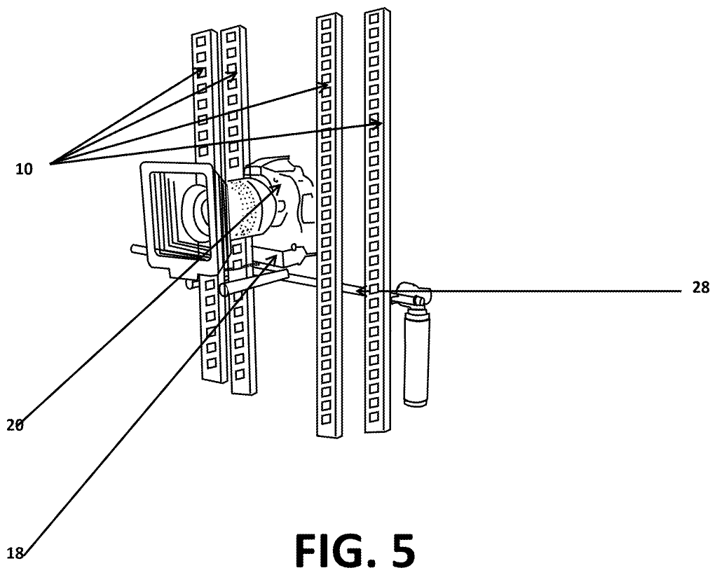

In FIG. 5 there is shown an adjustable lamp with the lighting elements (#10) mounted on a DSLR camera rig (#18) using and adjustable mechanism (#14) which in this case is based on a standard 15 mm rod and clamps. In this case the adjustable mechanism (#14) is different from the one used in FIG. 1, FIG. 2, FIG. 3 and FIG. 4. This mechanism not only allows for the adjustment of the distance and position between the lighting elements (#10) but also allows for the lamp to be mounted to a camera (#20), camera stabilizer, cage, c-stand arm or to an unmanned aerial vehicle. In this case the adjustable mechanism (#14) also allows for adding or removing lighting elements (#10), so any number of lighting elements (#10) can be used and easily changed as desired. The lighting element (#10) can have other devices attached, like batteries, dimmers, fans, heat sinks, etc., but it many instances only the bulbs and the corresponding necessary heat eliminating device would be all that is required so that the lighting element (#10) can be as light and inexpensive as possible. The metal frame to which the bulbs are attached can serve as the heat sink to avoid using fans. A power connector (#24) would also be included so that the lighting element (#10) can be powered from a separated power supply or battery. Accessories can also be designed and used to modify the light produced by the lighting element (#10) such as, but not limited to, diffusers, barn doors, filters, etc. This type of adjustable mechanism (#14) keeps the lamp in the same position relative to the camera (#20) even when it is moved or panned. This is very useful in many cases, as when a subject need to be tracked by the camera (#20) and the lighting on the subject should not change with this movement.

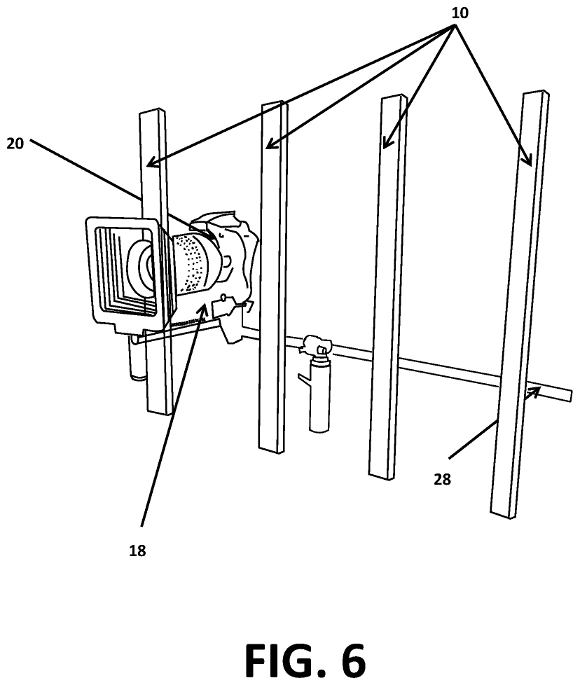

In FIG. 6 there is shown the same adjustable lamp as in FIG. 4 and FIG. 5, but with the lighting elements (#10) with more separation between them. In this case the effective size of the lamp becomes larger and the light produced becomes softer, casting less pronounced shadows on the subject.

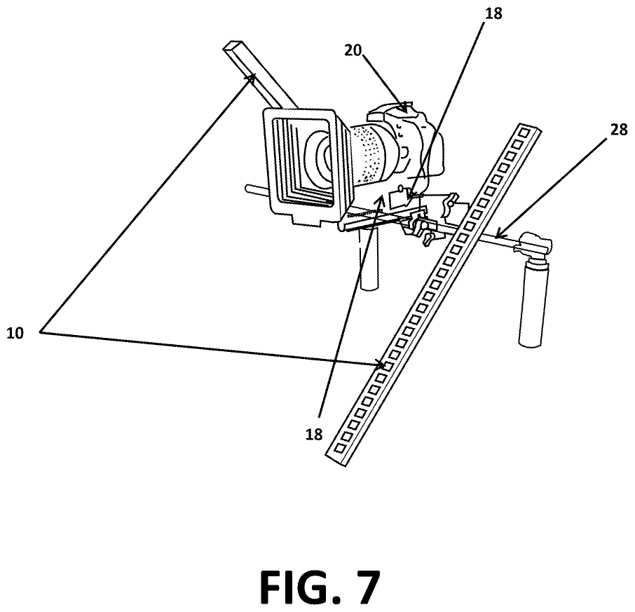

In FIG. 7 there is shown the same adjustable lamp as in FIG. 5 and FIG. 6 but with the lighting elements (#10) not parallel to each other. FIG. 7 shows that in this case the adjustable mechanism (#14) allows not only for the separation or distance between the lighting elements (#10) to be adjusted but also the relative position between the lighting elements (#10) can be changed. As the position of the lighting elements (#10) can be modified, the direction and effect of the light on the subject will be modified, without the need for additional accessories or light modifiers as umbrellas, softboxes, etc.

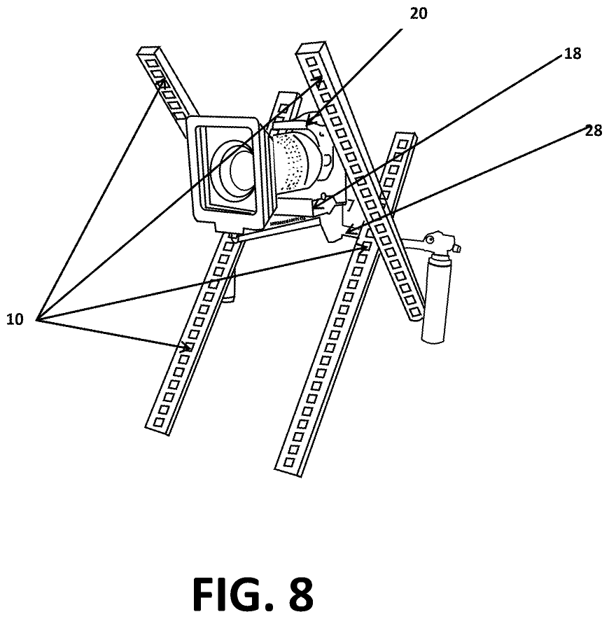

In FIG. 8 there is shown the same adjustable lamp as in FIG. 7 but with 4 lighting elements (#10) instead of two. The lighting elements (#10) are divided into two pairs as per their position and the direction of the light they produce, with both lighting elements (#10) in the same pair lighting in the same direction, but in a different direction as the other pair. FIG. 8 shows that the lighting elements (#10) can be configured for different lighting schemes. In this case the lighting elements (#10) are set in what is commonly called a “clamshell” or “beauty” scheme, but since the adjustable lamp is attached directly to the camera (#20), the lighting will follow the camera as it follows the subject. Since the lighting elements (#10) are adjustable other lighting schemes could be achieved, just by moving the lighting elements (#10) using the adjustable mechanism (#14). This is also true when the adjustable lamp is not attached to the camera. Other accessories like extensions, clamps, cables, adapters, filters, barn doors, different light modifiers and many other accessories can be used with the adjustable lamp and can also be part of a complete kit available to the user.

1. An apparatus for lighting for photography, video, cine or any image capture application, comprising two or more light emitting devices or arrays of one or more bulbs to be adjusted by modifying the distance between them and thus modifying the general quality of the light it produces.

2. The apparatus of claim 1 wherein the adjustable mechanism allows not only for the separation or distance between the lighting elements to be adjusted but also the relative position between the lighting elements to be changed, so that the lighting elements can face in different directions.

3. The apparatus of claim 1 wherein the lighting elements can be adjusted symmetrically or asymmetrically, allowing the distance and position between the lighting elements to vary independently from each other.

4. The invention apparatus of claim 1 wherein some or all of the lighting elements have different sizes.

5. The apparatus of claim 1 wherein some or all of the lighting elements have different shapes.

6. The invention apparatus of claim 1 wherein the lighting elements have one or more clamps that allow the use of accessories to modify the distance and or position of said lighting elements.

7. The apparatus of claim 6 wherein the clamp or clamps attached to the lighting elements are designed to fit the industry standard 15 mm rods normally used in camera cages or rigs, so that the adjustable lamp can be used directly mounted to said cages or rigs.

8. The apparatus of claim 6 wherein the clamp or clamps attached to the lighting elements are designed to fit an unmanned aerial vehicle so that the adjustable lamp can be used directly mounted to said unmanned aerial vehicle.

9. The apparatus of claim 6 wherein the clamp or clamps attached to the lighting elements are designed to fit a camera stabilizer, so that the adjustable lamp can be used directly mounted to said camera stabilizer.

10. The apparatus of claim 6 wherein the clamp or clamps attached to the lighting elements fit the industry standard arm of a c-stand commonly used in lighting applications in the movie, video or photography industry, so that the lighting elements of the adjustable lamp can be used directly mounted to said c-stands.

11. The apparatus of claim 1 wherein the lighting elements have their own rechargeable battery.

12. The apparatus of claim 1 wherein the lighting elements have a power connector which allows for an external battery or power adapter to supply the necessary power for the lighting element to operate.

13. The apparatus of claim 1 wherein the lighting elements use a metallic frame to dissipate the heat generated by the bulbs when operated, so that there is no need for mechanical means of dissipation.
